(19) United States
(12) Patent Application Publication
(10) Pub. No.: US 2024/0301243 A1
(43) Pub. Date: Sep. 12, 2024

(54) ULTRAVIOLET-CURABLE COMPOSITION

(71) Applicant: SEKISUI CHEMICAL CO., LTD., Osaka (JP)

(72) Inventors: Shinji KAWADA, Osaka (JP); Tomoki TODA, Osaka (JP); Shuuji KAGE, Tokyo (JP); Chiharu OKUHARA, Osaka (JP); Kaito NEMOTO, Shiga (JP)

(73) Assignee: SEKISUI CHEMICAL CO., LTD., Osaka (JP)

(21) Appl. No.: 18/564,846

(22) PCT Filed: May 30, 2022
(86) PCT No.: PCT/JP2022/021976

§ 371 Date: Nov. 28, 2023

(30) Foreign Application Priority Data
Jun. 2, 2021 (JP) 2021-093190

(51) Int. Cl. C09J 4/00; B32B 7/12; B32B 37/12; C08F 220/18; C08F 220/28; C09J 5/00; C09J 133/06; C09J 133/14

(52) U.S. Cl. CPC C09J 4/00; B32B 7/12; B32B 37/1284; C08F 220/1809; C08F 220/1811; C08F 220/282; C09J 5/00; C09J 133/062; C09J 133/14; B32B 2037/1253; B32B 2255/26; B32B 2307/558; B32B 2307/748; C08F 2810/20; C09J 2433/00

(57) ABSTRACT

The present invention aims to provide a UV-curable composition having excellent printability, excellent UV reactivity in the presence of oxygen, and excellent adhesiveness at room temperature and high temperature. Provided is a UV-curable composition containing: a curing component containing a (meth)acrylate monomer and a crosslinking component; and a UV curing agent, the (meth)acrylate monomer including, in 100% by weight of the curing component, 50 to 85% by weight of a monomer that, in a form of a homopolymer, has a glass transition temperature of −70° C. to −30° C., a cured product being obtained by applying the composition to a substrate at a thickness of 150 μm and irradiating the composition, without sealing an upper surface of the applied composition, with UV light having a wavelength of 315 nm to 480 nm at an irradiance of 90 mW/cm² and a dose of 1,350 mJ/cm² in an atmospheric environment, the cured product having a gel fraction of 0.4 to 78%, a glass transition temperature of −35° C. to 10° C., a reaction percentage of 83% or higher, and a reaction progress percentage on a surface facing the atmosphere of 93% or higher relative to a surface facing the substrate.

### TECHNICAL FIELD

The present invention relates to a UV-curable composition having excellent printability, excellent UV reactivity in the presence of oxygen, and excellent adhesiveness at room temperature and high temperature.

### BACKGROUND ART

Adhesives are used to bond electronic components inside electronic devices such as smartphones and PCs. With a typical method of bonding using an adhesive, first, an adhesive sheet having separators on both surfaces of an adhesive is produced. Next, the adhesive sheet is cut to a desired shape. One separator is then removed from the cut adhesive sheet, and the exposed adhesive surface is bonded to a first adherend. Subsequently, the other separator is removed, and the exposed adhesive surface is bonded to a second adherend. With this method, part of the adhesive sheet is discarded after cutting, producing waste. In addition, air bubbles may be trapped at the bonding interface.

In view of the situation, methods have been studied in which no adhesive sheet is produced and an adhesive is printed in a predetermined shape before being bonded to an adherend. These methods can reduce waste production and also prevent air bubbles at the bonding interface.

For example, Patent Literature 1 discloses an invention to provide a radiation curable adhesive composition that allows fine patterning and exhibits high adhesion to various adherends such as metals and plastics. The radiation curable adhesive resin composition contains 10 to 70% by weight of an ethylenically unsaturated monomer not containing an aromatic ring, 1 to 10% by weight of a photopolymerization initiator, and 10 to 55% by weight of a crosslinking agent, wherein the composition contains 10 to 45% by weight of an alkyl (meth)acrylate having a C8-C18 alkyl group as the ethylenically unsaturated monomer not containing an aromatic ring and 10 to 50% by weight of a urethane poly(meth)acrylate having a weight average molecular weight of 20,000 to 100,000 as the crosslinking agent.

Patent Literature 2 discloses an invention to provide a photocurable adhesive composition that, even when irradiated with light in the presence of oxygen, gives a laminate having adhesive strength equivalent to that in the absence of oxygen. The photocurable adhesive composition contains (A) a (meth)acrylate oligomer, (B) a monofunctional (meth)acrylate monomer, (C) a bi- to tetra-functional (meth)acrylate monomer, (D) a photoreaction initiator, (E) a tackifier having a softening point of 70° C. to 150° C., and (F) a liquid plasticizer.

### CITATION LIST

### Patent Literature

Patent Literature 1: JP 2013-216742 A
Patent Literature 2: WO 2016/163152

### SUMMARY OF INVENTION

### Technical Problem

As described above, the methods in which no adhesive sheet is produced and an adhesive composition is printed in a predetermined shape before being bonded to an adherend can reduce waste production and also prevent air bubbles at the bonding interface. The adhesive composition is preferably cured with UV light to avoid heating adherends. However, curing the adhesive composition exposed and not covered with a separator may result in insufficient UV reactivity and insufficient adhesion to substrates. There is thus still room for improvement to provide a UV light-curable composition for printing that has excellent printability, excellent UV reactivity, and excellent adhesiveness at room temperature and high temperature.

The present invention aims to provide a UV-curable composition having excellent printability, excellent UV reactivity in the presence of oxygen, and excellent adhesiveness at room temperature and high temperature.

### Solution to Problem

The present disclosure 1 relates to a UV-curable composition containing: a curing component containing a (meth)acrylate monomer and a crosslinking component; and a UV curing agent, the (meth)acrylate monomer including, in 100% by weight of the curing component, 50 to 85% by weight of a monomer that, in a form of a homopolymer, has a glass transition temperature of −70° C. to −30° C., a cured product being obtained by applying the composition to a substrate at a thickness of 150 μm and irradiating the composition, without sealing an upper surface of the applied composition, with UV light having a wavelength of 315 nm to 480 nm at an irradiance of 90 mW/cm² and a dose of 1,350 mJ/cm² in an atmospheric environment, the cured product having a gel fraction of 0.4 to 78%, a glass transition temperature of −35° C. to 10° C., a reaction percentage of 83% or higher, and a reaction progress percentage on a surface facing the atmosphere of 93% or higher relative to a surface facing the substrate.

The present disclosure 2 relates to the UV-curable composition of the present disclosure 1, further containing a nonreactive component having no reactivity with the curing component.

The present disclosure 3 relates to the UV-curable composition of the present disclosure 2, wherein the nonreactive component is contained at a ratio of 0.1 to 140 parts by weight relative to 100 parts by weight of the curing component.

The present disclosure 4 relates to the UV-curable composition of the present disclosure 2 or 3, wherein the nonreactive component contains at least one of a thermoplastic resin or a tackifier.

The present disclosure 5 relates to the UV-curable composition of any one of the present disclosures 1 to 4, wherein the cured product has a reaction percentage of 80% or higher on both of the surface facing the atmosphere and the surface facing the substrate.

The present disclosure 6 relates to the UV-curable composition of any one of the present disclosures 2 to 5, the crosslinking component has reactivity with the curing component or has reactivity with the curing component and the nonreactive component.

The present disclosure 7 relates to the UV-curable composition of any one of the present disclosures 1 to 6, wherein the crosslinking component has at least one binding functional group selected from the group consisting of an isocyanate group, an epoxy group, an aldehyde group, a hydroxy group, an amino group, a (meth)acrylate group, and a vinyl group.

The present disclosure 8 relates to the UV-curable composition of any one of the present disclosures 1 to 7, wherein the crosslinking component contains a (meth)acrylate monomer that, in a form of a homopolymer, has a gel fraction of 80% or higher.

The present disclosure 9 relates to the UV-curable composition of any one of the present disclosures 1 to 8, wherein the crosslinking component is a (meth)acrylate monomer having a viscosity at 25° C. of 10,000 cps or higher and is contained in an amount of 0.1 to 25% by weight in 100% by weight of the curing component.

The present disclosure 10 relates to the UV-curable composition of any one of the present disclosures 1 to 9, wherein the UV curing agent is contained in an amount of 0.2 to 10 parts by weight relative to 100 parts by weight of the curing component.

The present disclosure 11 relates to the UV-curable composition of the present disclosure 10, wherein the UV curing agent is contained in an amount of 0.4 to 5 parts by weight relative to 100 parts by weight of the curing component.

The present disclosure 12 relates to the UV-curable composition of any one of the present disclosures 1 to 11, wherein the curing component contains a nitrogen-containing monomer.

The present disclosure 13 relates to the UV-curable composition of the present disclosure 12, wherein the nitrogen-containing monomer is contained in an amount of 5 to 33% by weight in 100% by weight of the curing component.

The present disclosure 14 relates to the UV-curable composition of the present disclosure 12 or 13, wherein the nitrogen-containing monomer includes a monomer having a lactam structure.

The present disclosure 15 relates to the UV-curable composition of any one of the present disclosures 1 to 14, wherein the cured product has a gel fraction of 15 to 67%.

The present disclosure 16 relates to the UV-curable composition of any one of the present disclosures 1 to 15, which is a UV-curable composition for printing.

The present disclosure 17 relates to the UV-curable composition of the present disclosure 16, which is used for screen printing or ink-jet printing.

The present disclosure 18 relates to an adhesive sheet including: a substrate; and an adhesive layer on at least one surface of the substrate, the adhesive layer containing the UV-curable composition of any one of the present disclosures 1 to 17.

The present disclosure 19 relates the adhesive sheet of the present disclosure 18, wherein the adhesive layer is disposed on part of the substrate.

The present disclosure 20 relates to a laminate including a first adherend and a second adherend bonded to each other with the adhesive layer of the adhesive sheet of the present disclosure 18 or 19.

The present disclosure 21 relates to a method for producing a laminate, including: applying the UV-curable composition of any one of the present disclosures 1 to 17 to a first adherend; exposing the UV-curable composition to light to form an adhesive layer; and bonding a second adherend to the adhesive layer to form a laminate.

The present disclosure 22 relates to the method for producing a laminate of the present disclosure 21, wherein the UV-curable composition is applied by ink-jet printing, screen printing, spray coating, spin coating, gravure offset printing, or reverse offset printing, and the UV-curable composition is applied to part of the first adherend.

The present invention is described in detail below.

The present inventors focused on UV-curable compositions containing a curing component containing a (meth)acrylate monomer and a crosslinking component as well as a UV curing agent. The present inventors have found out that it is difficult for such compositions to have sufficient UV reactivity when they are exposed and not covered with a separator during curing. Studies by the present inventors have shown that incorporating a specific amount of a monomer that in the form of a homopolymer has a glass transition temperature of −30° C. to −70° C. can improve the UV reactivity while ensuring adhesiveness. After further studies, the inventors have found out that adjusting the reaction percentage of the resulting cured product to 83% or higher, while adjusting the reaction progress percentage on a surface facing the atmosphere to 93% or higher relative to a surface facing a substrate, can ensure sufficient UV reactivity in the presence of oxygen. The inventors also have found out that adjusting the gel fraction of the resulting cured product to 0.4 to 78% and the glass transition temperature thereof to 10° C. to −35° C. can ensure the printability and the adhesiveness at room temperature and high temperature. The inventors thus completed the present invention.

The UV-curable composition contains a curing component containing a (meth)acrylate monomer and a crosslinking component.

The “(meth)acryl” herein means acryl or methacryl. The “(meth)acrylate monomer” means a monomer having a (meth)acryloyl group. The “!(meth)acryloyl” means acryloyl or methacryloyl.

Examples of the (meth)acrylate monomer include (meth)acrylate compounds and epoxy (meth)acrylates.

The “(meth)acrylate” herein means acrylate or methacrylate. The “epoxy (meth)acrylate” means a compound obtained by reacting all the epoxy groups in an epoxy compound with (meth)acrylic acid.

Examples of monofunctional (meth)acrylate compounds include methyl (meth)acrylate, ethyl (meth)acrylate, propyl (meth)acrylate, n-butyl (meth)acrylate, isobutyl (meth)acrylate, t-butyl (meth)acrylate, 2-ethylhexyl (meth)acrylate, n-octyl (meth)acrylate, n-heptyl (meth)acrylate, isooctyl (meth)acrylate, isononyl (meth)acrylate, isodecyl (meth)acrylate, lauryl (meth)acrylate, isomyristyl (meth)acrylate, stearyl (meth)acrylate, 2-hydroxyethyl (meth)acrylate, 2-hydroxypropyl (meth)acrylate, 2-hydroxy-3-phenoxypropyl (meth)acrylate, 2-hydroxybutyl (meth)acrylate, 4-hydroxybutyl (meth)acrylate, cyclohexyl (meth)acrylate, isobornyl (meth)acrylate, bicyclopentenyl (meth)acrylate, benzyl (meth)acrylate, 2-methoxyethyl (meth)acrylate, 2-ethoxyethyl (meth)acrylate, 2-butoxyethyl (meth)acrylate, 2-phenoxyethyl (meth)acrylate, methoxyethylene glycol (meth)acrylate, methoxypolyethylene glycol (meth)acrylate, phenoxydiethylene glycol (meth)acrylate, phenoxypolyethylene glycol (meth)acrylate, tetrahydrofurfuryl (meth)acrylate, tetrahydrofurfuryl alcohol acrylic acid multimer ester, ethyl carbitol (meth)acrylate, 2,2,2-trifluoroethyl (meth)acrylate, 2,2,3,3-tetrafluoropropyl (meth)acrylate, 1H,1H,5H-octafluoropentyl (meth)acrylate, imide (meth)acrylate, dimethylaminoethyl (meth)acrylate, diethylaminoethyl (meth)acrylate, 2-(meth)acryloyloxyethyl succinate, 2-(meth)acryloyloxyethyl hexahydrophthalate, 2-(meth)acryloyloxyethyl 2-hydroxypropylphthalate, 2-(meth)acryloyloxyethyl phosphate, (3-ethyloxetan-3-yl) methyl (meth)acrylate, 2-(((butylamino)carbonyl)oxy) ethyl (meth)acrylate, (3-propyloxetan-3-yl) methyl (meth)acrylate, (3-butyloxetan-3-yl) methyl (meth)acrylate, (3-ethyloxetan-3-yl) ethyl (meth)acrylate, (3-ethyloxetan-3-yl) propyl (meth)acrylate, (3-ethyloxetan-3-yl) butyl (meth)acrylate, (3-ethyloxetan-3-yl) pentyl (meth)acrylate, (3-ethyloxetan-3-yl) hexyl (meth)acrylate, γ-butyrolactone (meth)acrylate, (2,2-dimethyl-1,3-dioxolan-4-yl) methyl (meth)acrylate, (2-methyl-2-ethyl-1,3-dioxolan-4-yl) methyl (meth)acrylate, (2-methyl-2-isobutyl-1,3-dioxolan-4-yl) methyl (meth)acrylate, (2-cyclohexyl-1,3-dioxolan-4-yl) methyl (meth)acrylate, and cyclic trimethylolpropane formal acrylate.

Examples of bifunctional (meth)acrylate compounds include 1,3-butanediol di(meth)acrylate, 1,4-butanediol di(meth)acrylate, 1,6-hexanediol di(meth)acrylate, 1,9-nonanediol di(meth)acrylate, 1,10-decanediol di(meth)acrylate, ethylene glycol di(meth)acrylate, diethylene glycol di(meth)acrylate, tetraethylene glycol di(meth)acrylate, polyethylene glycol di(meth)acrylate, 2-n-butyl-2-ethyl-1,3-propanediol di(meth)acrylate, dipropylene glycol di(meth)acrylate, tripropylene glycol di(meth)acrylate, polypropylene glycol di(meth)acrylate, neopentyl glycol di(meth)acrylate, ethylene oxide-added bisphenol A di(meth)acrylate, propylene oxide-added bisphenol A di(meth)acrylate, ethylene oxide-added bisphenol F di(meth)acrylate, dimethylol dicyclopentadienyl di(meth)acrylate, ethylene oxide-modified isocyanuric acid di(meth)acrylate, 2-hydroxy-3-(meth)acryloyloxypropyl (meth)acrylate, carbonate diol di(meth)acrylate, polyether diol di(meth)acrylate, polyester diol di(meth)acrylate, polycaprolactone diol di(meth)acrylate, polybutadiene diol di(meth)acrylate, and tricyclodecane dimethanol di(meth)acrylate.

Examples of tri- or higher functional (meth)acrylate compounds include trimethylolpropane tri(meth)acrylate, ethylene oxide-added trimethylolpropane tri(meth)acrylate, propylene oxide-added trimethylolpropane tri(meth)acrylate, caprolactone-modified trimethylolpropane tri(meth)acrylate, ethylene oxide-added isocyanuric acid tri(meth)acrylate, glycerol tri(meth)acrylate, propylene oxide-added glycerol tri(meth)acrylate, pentaerythritol tri(meth)acrylate, tris(meth)acryloyloxyethyl phosphate, ditrimethylolpropane tetra(meth)acrylate, pentaerythritol tetra(meth)acrylate, dipentaerythritol penta(meth)acrylate, and dipentaerythritol hexa(meth)acrylate.

Examples of the epoxy (meth)acrylates include bisphenol A epoxy (meth)acrylate, bisphenol F epoxy (meth)acrylate, bisphenol E epoxy (meth)acrylate, and caprolactone-modified products of these.

The (meth)acrylate monomer includes a monomer that in the form of a homopolymer has a glass transition temperature (Tg) of −70° C. to −30° C. in an amount of 50 to 85% by weight relative to the whole amount of the curing component. This allows the UV-curable composition to have improved UV reactivity while having excellent adhesiveness. The lower limit of the amount of the monomer is preferably 60% by weight, and the upper limit thereof is more preferably 77% by weight. The lower limit of the glass transition temperature of the homopolymer is preferably −50° C., and the upper limit thereof is more preferably −35° C.

The glass transition temperature of the homopolymer is the tan δ peak temperature obtained in the measurement of dynamic viscoelasticity at a frequency of 1 Hz in a shear mode. Specifically, the glass transition temperature of the homopolymer can be measured by the following procedure.

### (Measurement of Glass Transition Temperature of Homopolymer)

The (meth)acrylate monomer in an amount of 100 parts by weight is stirred and mixed with 0.2 parts by weight of a photopolymerization initiator to provide a photopolymerizable composition. The obtained photopolymerizable composition is formed into a photopolymerizable composition layer having a thickness of 100 μm. The photopolymerizable composition layer is irradiated with UV light with an irradiation energy of 1,350 mJ/cm², with the irradiance set at 30 mW/cm² at a wavelength of 365 nm and at 60 mW/cm² at a wavelength of 405 nm. The photopolymerizable composition layer is thereby cured to provide a homopolymer cured product.

The viscoelasticity of the obtained homopolymer cured product is measured in a shear mode under the conditions of raising the temperature from −100° C. to 200° at a temperature increase rate of 3° C./min with a frequency of 1 Hz and a strain of 0.1%. In the obtained measurement results, the loss tangent peak temperature is defined as the glass transition temperature Tg (° C.).

The lower limit of the amount of the (meth)acrylate monomer in 100 parts by weight of the UV-curable composition is preferably 40 parts by weight, and the upper limit thereof is preferably 99 parts by weight. When the amount of the (meth)acrylate monomer is 40 parts by weight or more, the resulting adhesive can have excellent adhesion at high temperature. When the amount of the (meth)acrylate monomer is 99 parts by weight or less, the adhesive can be excellent in adhesion to various substrates and other properties than adhesion. The lower limit of the amount of the (meth)acrylate monomer is more preferably 55 parts by weight, and the upper limit thereof is more preferably 90 parts by weight.

The UV-curable composition contains a crosslinking component. The crosslinking component may be any compound having two or more binding functional groups in one molecule. The crosslinking component is preferably one having reactivity with the (meth)acrylate monomer or one having reactivity with the (meth)acrylate monomer and the later-described nonreactive component.

Here, a (meth)acrylate monomer having two or more binding functional groups in one molecule is treated as being both the (meth)acrylate monomer and the crosslinking component.

The crosslinking component preferably has at least one binding functional group selected from the group consisting of an isocyanate group, an epoxy group, an aldehyde group, a hydroxy group, an amino group, a (meth)acrylate group, and a vinyl group. A crosslinking component having any of these binding functional groups can form crosslinking bonds at a sufficient density in curing.

The crosslinking component preferably contains a (meth)acrylate monomer that in the form of a homopolymer has a gel fraction of 80% or higher. Using such a (meth)acrylate monomer can improve the cohesive force of the UV-curable composition, improving the printability of the composition and the adhesion of the resulting adhesive.

The crosslinking component preferably contains a (meth)acrylate monomer having a viscosity at 25° C. of 10,000 cps or higher. For example, a high-molecular-weight monomer (macromonomer) may be used. The crosslinking component preferably contains a bifunctional (meth)acrylate monomer. Using such a (meth)acrylate monomer can improve the cohesive force of the UV-curable composition, improving the printability of the composition and the adhesion of the resulting adhesive.

Specific examples of the crosslinking component include: radically polymerizable polyfunctional oligomers and monomers; polymers having a crosslinkable functional group; and macromonomers.

Examples of the radically polymerizable polyfunctional oligomers and monomers include trimethylolpropane triacrylate, tetramethylolmethane tetraacrylate, pentaerythritol triacrylate, pentaerythritol tetraacrylate, dipentaerythritol monohydroxypentaacrylate, dipentaerythritol hexaacrylate, and methacrylates of the same kinds. Other examples include 1,4-butylene glycol diacrylate, 1,6-hexanediol diacrylate, polyethylene glycol diacrylate, commercial oligoester acrylates, and methacrylates of the same kinds. These radically polymerizable polyfunctional oligomers and monomers may be used alone or in combination of two or more thereof.

The amount of the crosslinking component is preferably 0.1 to 25% by weight in 100% by weight of the curing component. When the amount of the crosslinking component is within the range, the cohesive force of the UV-curable composition can be appropriately improved, and the printability of the composition and the adhesion of the resulting adhesive can be improved. The lower limit of the amount of the crosslinking component is more preferably 2% by weight, and the upper limit thereof is more preferably 15% by weight.

The UV-curable composition contains a UV curing agent.

The UV curing agent is preferably a photoradical polymerization initiator. The UV curing agent and the photoradical polymerization initiator may be used alone or in combination of two or more thereof.

Examples of the photoradical polymerization initiator include benzophenone compounds, alkylphenone compounds, acylphosphine oxide compounds, titanocene compounds, oxime ester compounds, benzoin ether compounds, and thioxanthone compounds. Examples of the alkylphenone compounds include acetophenone compounds.

Specific examples of the photoradical polymerization initiator include 1-hydroxycyclohexyl phenyl ketone, 2-benzyl-2-(dimethylamino)-1-(4-((morpholino)phenyl)-1-butanone, 2-(dimethylamino)-2-((4-methylphenyl)methyl)-1-(4-(4-morpholinyl)phenyl)-1-butanone, 2,2-dimethoxy-1,2-diphenylethan-1-one, bis(2,4,6-trimethylbenzoyl)phenylphosphine oxide, 2-methyl-1-(4-methylthiophenyl)-2-morpholinopropan-1-one, 1-(4-(2-hydroxyethoxy)-phenyl)-2-hydroxy-2-methyl-1-propan-1-one, 1-(4-(phenylthio)phenyl)-1,2-octanedione-2-(0-benzoyl oxime), 2,4,6-trimethylbenzoyl diphenylphosphine oxide, benzoin methyl ether, benzoin ethyl ether, and benzoin isopropyl ether.

The lower limit of the amount of the UV curing agent relative to 100 parts by weight of the curing component is preferably 0.2 parts by weight, and the upper limit thereof is preferably 10 parts by weight. When the amount of the UV curing agent is within the range, the UV-curable composition can maintain excellent storage stability while having better UV curability. The lower limit of the amount of the UV curing agent is more preferably 0.4 parts by weight, and the upper limit thereof is more preferably 8 parts by weight. The lower limit is still more preferably 0.5 parts by weight, and the upper limit is still more preferably 6 parts by weight, particularly preferably 5 parts by weight. When the composition contains two or more UV curing agents, the amount of the UV curing agent refers to the total amount of all the UV curing agents contained.

The UV-curable composition may contain a nitrogen-containing monomer. The nitrogen-containing monomer may be any monomer having a nitrogen atom and a polymerizable group in the molecule. The nitrogen-containing monomer is preferably an amide compound having a vinyl group, more preferably a cyclic amide compound having a vinyl group, still more preferably a compound having a lactam structure.

Examples of the amide compound having a vinyl group include N-vinylacetamide and (meth)acrylamide compounds. Examples of the (meth)acrylamide compounds include N,N-dimethyl(meth)acrylamide, N-(meth)acryloylmorpholine, N-hydroxyethyl(meth)acrylamide, N,N-diethyl(meth)acrylamide, N-isopropyl(meth)acrylamide, and N,N-dimethylaminopropyl(meth)acrylamide.

Examples of the cyclic amide compound having a vinyl group include compounds represented by the following formula (1).

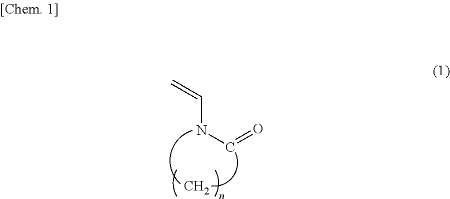

In the formula (1), n represents an integer of 2 to 6.

Examples of the compounds represented by the formula (1) include N-vinyl-2-pyrrolidone and N-vinyl-ε-caprolactam. In particular, N-vinyl-ε-caprolactam is preferred.

The nitrogen-containing monomer preferably includes a monomer having a negative e value. Examples of the monomer having a negative e value include N-vinylacetamide (e value=−1.57), N-vinyl-ε-caprolactam (e value=−1.18), N-vinyl-2-pyrrolidone (e value=−1.62), and N,N-dimethyl(meth)acrylamide (e value=−0.26).

The amount of the nitrogen-containing monomer can be used to adjust the reaction percentage in the cured product and the reaction progress percentage on the surface facing the atmosphere relative to the surface facing the substrate. Specifically, the amount of the nitrogen-containing monomer is preferably 5 to 33% by weight in 100% by weight of the curing component. When the amount of the nitrogen-containing monomer is 5% by weight or more, the UV reactivity in the presence of oxygen can be improved, which makes it easy to adjust to desired ranges the reaction percentage in the cured product and the reaction progress percentage on the surface facing the atmosphere relative to the surface facing the substrate. When the amount of the nitrogen-containing monomer is 33% by weight or less, the resulting adhesive has excellent adhesion to various substrates. The lower limit of the amount of the nitrogen-containing monomer is more preferably 10% by weight, and the upper limit thereof is more preferably 25% by weight.

The UV-curable composition may contain a nonreactive component having no reactivity with the curing component. The nonreactive component may be a compound containing no reactive double bond therein or a compound containing a reactive double bond but showing substantially no photopolymerizability. When containing the nonreactive component, the UV-curable heat-dissipating resin composition can have improved viscosity, so that the composition can form a thick coating film and can have excellent printability. The nonreactive component may show reactivity with a trigger such as heat or moisture after the UV-curable composition is photopolymerized. For example, the nonreactive component may contain an epoxy resin to be cured by heat or may contain an isocyanate compound to be cured by moisture or alcohol.

The nonreactive component preferably contains at least one of a thermoplastic resin or a tackifier.

Specific examples of the thermoplastic resin include solvent-free acrylic polymers and SEBS elastomers.

Examples of the solvent-free acrylic polymers include: polymers of at least one monomer selected from alkyl (meth)acrylates having a C1-C20 alkyl group; and copolymers of this monomer and other copolymerizable monomer(s).

Examples of commercial solvent-free acrylic polymers include ARUFON UP-1000 series, UH-2000 series, and UC-3000 series available from Toagosei Co., Ltd. and acrylic block copolymers KURARITY LA series and LK series available from Kuraray Co., Ltd.

Examples of the tackifier include rosin resins and terpene resins.

The rosin resin may be, for example, a rosin diol.

The rosin diol may be any rosin-modified diol having two rosin skeletons and two hydroxy groups in the molecule. Diols having a rosin component in the molecule are generically referred to as rosin polyols. Rosin polyols are classified into the polyether type in which the skeleton excluding that of the rosin component is like polypropylene glycol (PPG) and the polyester type such as condensed polyester polyols, lactone-type polyester polyols, and polycarbonate diols.

Examples of the rosin diol include rosin esters obtained by reaction between a rosin and a polyhydric alcohol, epoxy-modified rosin esters obtained by reaction between a rosin and an epoxy compound, and modified rosins having a hydroxy group such as polyethers having a rosin skeleton. These can be produced by a conventionally known method.

Examples of the rosin component include abietic acid and its derivatives (e.g., dehydroabietic acid, dihydroabietic acid, tetrahydroabietic acid, diabietic acid, neoabietic acid), pimaric acid-type resin acids such as levopimaric acid, hydrogenated rosins obtained by hydrogenation of these, and disproportionated rosins obtained by disproportionation of these.

Examples of commercial products of the rosin resin include Pine crystal series (D-6011, KE-615-3, KR-614, KE-100, KE-311, KE-359, KE-604, D-6250) available from Arakawa Chemical Industries, Ltd.

Examples of the terpene resin include terpene phenolic resins.

The terpene phenolic resin is a copolymer of a phenol and a terpene resin that is an essential oil constituent obtained from natural products such as turpentine or orange peels, and includes a partially hydrogenated terpene phenolic resin obtained by partially hydrogenating the copolymer and a fully hydrogenated terpene phenolic resin obtained by fully hydrogenating the copolymer.

Here, the fully hydrogenated terpene phenolic resin refers to a terpene resin (tackifier resin) obtained by substantially fully hydrogenating a terpene phenolic resin. The partially hydrogenated terpene phenolic resin refers to a terpene resin (tackifier resin) obtained by partially hydrogenating a terpene phenolic resin. The terpene phenolic resin has a terpene-derived double bond and a phenol-derived aromatic ring double bond. Accordingly, the fully hydrogenated terpene phenolic resin means a tackifier resin in which both the terpene site and phenol site are fully or mostly hydrogenated. The partially hydrogenated terpene phenolic resin means a terpene phenolic resin in which the hydrogenation of these sites is not fully but partially performed. Any hydrogenation method and any reaction type may be employed.

Examples of the commercial products of the terpene phenolic resin include YS POLYSTER NH (fully hydrogenated terpene phenolic resin) available from Yasuhara Chemical Co., Ltd.

The nonreactive component may contain a plasticizer such as an organic acid ester, an organophosphate ester, or an organophosphite ester or a liquid substance having an acid value such as xylene or polyol.

Examples of the plasticizer include organic acid ester plasticizers such as monobasic organic acid esters and polybasic organic acid esters and phosphoric acid plasticizers such as organophosphate plasticizers and organophosphite plasticizers. Preferred among these are organic acid ester plasticizers. These plasticizers may be used alone or in combination of two or more thereof.

Examples of the organic acid esters include monobasic organic acid esters and polybasic organic acid esters.

Non-limiting examples of the monobasic organic acid esters include glycol esters obtained by reaction between a monobasic organic acid (e.g., butyric acid, isobutyric acid, caproic acid, 2-ethyl butyric acid, heptylic acid, n-octylic acid, 2-ethylhexanoic acid, pelargonic acid (n-nonylic acid), or decylic acid) and a glycol (e.g., triethylene glycol, tetraethylene glycol, or tripropylene glycol).

Non-limiting examples of the polybasic organic acid esters include ester compounds obtained by reaction between a polybasic organic acid (e.g., adipic acid, sebacic acid, or azelaic acid) and a C4-C8 linear or branched alcohol.

Specific examples of the organic acid esters include triethylene glycol-di-2-ethylbutyrate (3GH), triethylene glycol-di-2-ethylhexanoate (3G0), triethylene glycol dicaprylate, triethylene glycol di-n-octanoate, and triethylene glycol-di-n-heptanoate (3G7). Examples also include tetraethylene glycol-di-n-heptanoate (4G7), tetraethylene glycol-di-2-ethylhexanoate, dibutyl sebacate, dioctyl azelate, dibutyl carbitol adipate, ethylene glycol di-2-ethylbutyrate, and 1,3-propylene glycol di-2-ethylbutyrate. Examples further include 1,4-butylene glycol di-2-ethylbutyrate, diethylene glycol-di-2-ethylbutyrate, diethylene glycol-di-2-ethylhexanoate, and dipropylene glycol di-2-ethylbutyrate. Examples further include triethylene glycol di-2-ethylpentanoate, tetraethylene glycol-di-2-ethylbutyrate (4GH), diethylene glycol dicaprylate, dihexyl adipate (DHA), dioctyl adipate, hexyl cyclohexyl adipate, diisononyl adipate, and heptyl nonyl adipate. Examples also include oil-modified sebacic alkyds, mixtures of phosphates and adipates, and mixed type adipates prepared from C4-C9 alkyl alcohols and C4-C9 cyclic alcohols.

The organophosphate ester or organophosphite ester may be a compound obtained by condensation reaction between phosphoric acid or phosphorous acid and an alcohol. In particular, preferred is a compound obtained by condensation reaction between a C1-C12 alcohol and phosphoric acid or phosphorous acid. Examples of the C1-C12 alcohol include methanol, ethanol, butanol, hexanol, 2-ethyl butanol, heptanol, octanol, 2-ethylhexanol, decanol, dodecanol, butoxy ethanol, butoxyethoxy ethanol, benzyl alcohol.

Specific examples of the organophosphate ester or organophosphite ester include trimethyl phosphate, triethyl phosphate, tripropyl phosphate, tributyl phosphate, tri(2-ethylhexyl) phosphate, tri(butoxyethyl) phosphate, tri(2-ethylhexyl) phosphite, isodecylphenyl phosphate, and triisopropyl phosphate.

The amount of the nonreactive component relative to 100 parts by weight of the curing component is preferably 0.1 to 140 parts by weight. When the amount of the nonreactive component is within the range, the UV-curable composition can have improved viscosity, so that the composition can form a thick coating film and have excellent printability. The lower limit of the amount of the nonreactive component is more preferably 10 parts by weight, and the upper limit thereof is more preferably 90 parts by weight.

The UV-curable composition may contain a defoamer. Non-limiting examples of the defoamer include silicone defoamers, acrylic polymer defoamers, vinyl ether polymer defoamers, and olefin polymer defoamers.

The UV-curable composition may further contain a known additive such as a viscosity modifier, a silane coupling agent, a sensitizer, a heat-curing agent, a curing retardant, an antioxidant, a storage stabilizer, a dispersant, or a filler, as long as the purposes of the present invention are not impaired. To prevent a reduction in the UV reactivity, the UV-curable composition preferably contains substantially no organic solvent. Specifically, the amount of the organic solvent is preferably 1.5% by weight or less relative to 100% by weight of the UV-curable composition.

In the present invention, a cured product is obtained by applying the UV-curable composition to a substrate at a thickness of 150 μm and irradiating the composition, without sealing an upper surface of the applied composition, with UV light having a wavelength of 315 nm to 480 nm at an irradiance of 90 mW/cm² and a dose of 1,350 mJ/cm² in an atmospheric environment, and the cured product has a gel fraction of 0.4 to 78%, a glass transition temperature of −35° C. to 10° C., a reaction percentage of 83% or higher, and a reaction progress percentage on a surface facing the atmosphere of 93% or higher relative to a surface facing the substrate. At this time, the composition may be irradiated with multiple wavelengths within the wavelength range from 315 nm to 480 nm, as long as the total irradiance is 90 mW/cm² and the dose is 1,350 mJ/cm². The substrate is preferably a PET film having a release-treated surface.

Under the conditions above, the UV-curable composition is applied to the substrate and then irradiated with UV light in the presence of oxygen, with the upper surface of the applied composition not covered with a separator. Therefore, the surface (front surface) facing the atmosphere reflects the UV reactivity in the presence of oxygen. In contrast, since the coating film has a thickness of 150 μm, the surface (back surface) facing the substrate reflects the UV reactivity in the absence of oxygen.

The cured product having a gel fraction of 0.4 to 78% can have improved cohesive force, achieving excellent adhesiveness to various substrates at room temperature. The cured product can further have high elastic modulus at high temperature, achieving excellent high-temperature adhesiveness. The lower limit of the gel fraction of the cured product is preferably 15%, and the upper limit thereof is preferably 67%. The gel fraction of the cured product can be adjusted by, for example, adjusting the amount of the crosslinking component.

The cured product having a glass transition temperature of −35° C. to 10° C. can have excellent shock absorption. The lower limit of the glass transition temperature of the cured product is preferably −30° C., and the upper limit is more preferably 1° C., still more preferably −10° C.

The cured product having a reaction percentage of 83% or higher can have improved cohesive force, achieving excellent adhesiveness. The upper limit of the reaction percentage of the cured product is preferably 100%. The reaction percentage is calculated from the solid content of the cured product.

The cured product having a reaction progress percentage of 93% or higher on the surface facing the atmosphere relative to the surface facing the substrate can have good adhesion on the surface and excellent stable adhesiveness. The upper limit of the reaction progress percentage is preferably 100%. The reaction progress percentage is calculated from the solid content of the cured product and the ratio between the reaction percentages on the front and back surfaces. The reaction percentages on the front and back surfaces are respectively calculated from infrared absorption spectra (IR spectra) obtained from the front and back surfaces of the cured product.

The cured product preferably has a reaction percentage of 80% or higher on both of the surface (front surface) facing the atmosphere and the surface (back surface) facing the substrate. The reaction percentage on the surface (front surface) facing the atmosphere (herein also referred as a “front surface reaction percentage”) reflects the UV reactivity in the presence of oxygen, whereas the reaction percentage on the surface (back surface) facing the substrate (herein also referred to as a “back surface reaction percentage”) reflects the UV reactivity in the absence of oxygen. The reaction percentage of 80% or higher on both the surface (front surface) facing the atmosphere and the surface (back surface) facing the substrate indicates sufficiently high UV reactivity in the presence of oxygen, and thus allows the composition to be used in the method in which the composition is printed in a desired shape before being bonded to an adherend.

Ideally, both the front surface reaction percentage and the back surface reaction percentage are high. However, in the exposed state (in the presence of oxygen), the back surface reaction percentage is typically higher, whereas in the sealed state (in the absence of oxygen), the front surface reaction percentage is typically higher. Thus, a high front surface reaction percentage relative to the back surface reaction percentage (i.e., high reaction progress percentage) indicates that the reaction has appropriately progressed even in the exposed state as in the sealed state.

The front surface reaction percentage can be determined by optically analyzing a monomer-derived structure or a polymer-derived structure in the cured product from the atmosphere side (front side). The back surface reaction percentage can be determined by optically analyzing a monomer-derived structure or a polymer-derived structure in the cured product from the substrate side (back side). The optical measurement may be performed by, for example, a method of obtaining an IR spectrum by the attenuated total reflection (ATR) method and determining the vinyl group content of the cured product from the absorbance value at 810 cm⁻¹ in the spectrum.

Specifically, the reaction percentage, the reaction progress percentage, the front surface reaction percentage, and the back surface reaction percentage can be measured by the following procedure.

### (Production of Cured Product)

The UV-curable composition is applied with an applicator to a thickness of 150 μm to a PET sheet having one release-treated surface as the substrate. Subsequently, without sealing the upper surface of the applied composition, the composition is irradiated with UV light with an irradiation energy of 1,350 mJ/cm² in an atmospheric environment using an UV irradiator set to a UV irradiance of 30 mW/cm² at a wavelength of 365 nm and a UV irradiance of 60 mW/cm² at a wavelength of 405 nm. The UV-curable composition is thereby cured to provide a cured product.

### (Measurement of Reaction Percentage, Front Surface Reaction Percentage, Back Surface Reaction Percentage, and Reaction Progress Percentage)

FIGS. 1 and 2 are views for illustrating a method for calculating the front surface reaction percentage and the back surface reaction percentage. FIG. 1 illustrates a sample preparation method and measurement targets. FIG. 2 illustrates a method for calculating the front surface reaction percentage and the back surface reaction percentage from obtained IR spectra. A sample of the cured product produced as above (cured in an atmospheric environment without sealing the upper surface of the applied composition; see FIG. 1(a)) is defined as a “cured product A”. Another sample is produced by UV light (UV) irradiation in the same manner as for the cured product A, except that a UV-curable composition 10 is interposed between PET sheets 20 (see FIG. 1(b)). This sample is defined as a “cured product B”.

First, about 0.3 g of the cured product A is placed in an aluminum pan, to which a solvent mixture containing THF, acetone, and ethanol at a THF:acetone:ethanol weight ratio of 8:1:1 is added slowly without splashing the cured product sample, and the sample is left to swell for about two hours. This is followed by drying at 110° C. for 30 minutes, at 170° C. for one hour, and at 190° C. for 30 minutes. After drying, it is confirmed that the mixed solvent has completely evaporated. The aluminum pan after drying and the dried sample are then weighed. The reaction percentage is calculated by the following formula.

Reaction percentage [%]=100−(Total weight of aluminum pan and sample after drying−Weight of aluminum pan before drying)/(Total weight of aluminum pan and sample before drying−Weight of aluminum pan before drying)×100

Next, the front and back surfaces of the cured product A are subjected to measurement of IR spectra (infrared absorption spectra) as shown in FIG. 2 by the ATR method using a Fourier transform infrared spectrometer, and the absorbance values at 810 cm⁻¹ are obtained. The obtained value of the front surface and the obtained value of the back surface are defined as “Absorbance without PET (front surface)” and “Absorbance without PET (back surface)”, respectively.

Further, the PET sheet is removed from the irradiated surface (front surface) of the cured product B during curing. The surface (front surface) is then subjected to measurement of an IR spectrum as shown in FIG. 2 in the same manner by the ATR method, and the absorbance value at 810 cm⁻¹ is obtained. The obtained value is defined as “Absorbance with PET (front surface)”.

From these values and the reaction percentage above, the front surface reaction percentage, the back surface reaction percentage, and the reaction progress percentage are calculated by the following formulas.

Front surface reaction percentage [%]=Reaction percentage [%]×Absorbance without PET (front surface)/Absorbance with PET (front surface)

Back surface reaction percentage [%]=Reaction percentage [%]×Absorbance without PET (back surface)/Absorbance with PET (front surface)

Reaction progress percentage [%]=Absorbance without PET (front surface)/Absorbance without PET (back surface)×100

The “Absorbance without PET (front surface)/Absorbance with PET (front surface)” and the “Absorbance without PET (back surface)/Absorbance with PET (front surface)” mean the percentage values of the “Absorbance without PET (front surface)” and the “Absorbance without PET (back surface)”, with the absorbance at 810 cm-1 measured on the uncured UV-curable composition taken as 0% (minimum) and the “Absorbance with PET” as 100% (maximum). For example, the “Absorbance without PET (front surface)/Absorbance with PET (front surface)” means Reaction percentage X in FIG. 2 and is represented by the following formula.

$$Reaction percentage X = B / A$$

$$A = \vert ABS . M - ABS \text{.0} \vert$$

$$B = \vert ABS . D - ABS \text{.0} \vert$$

To adjust the reaction percentage, the reaction progress percentage, the front surface reaction percentage, and the back surface reaction percentage of the cured product to the ranges above, the UV reactivity in the presence of oxygen is increased so as to increase the front surface reaction percentage. The front surface reaction percentage may be increased by a method such as: increasing the amount of the nitrogen-containing monomer compounded; increasing the amount of the crosslinking component compounded; using a crosslinking component that in the form of a homopolymer has high gel fraction ((meth)acrylate monomer that in the form of a homopolymer has high gel fraction); using a large amount of the UV curing agent; or increasing the amount of the nonreactive component compounded, for example.

The UV-curable composition may be used in any application, but it is suitable for printing, for example. The UV-curable composition is preferably a UV-curable composition for printing. The method for printing the UV-curable composition is not limited. Examples thereof include screen printing, ink-jet printing, and gravure printing. Preferred among these are screen printing and ink-jet printing. Applying the composition in a desired pattern by printing on an adherend (substrate) to form an adhesive layer has the advantage of eliminating the cutting process, as compared with producing an adhesive in a desired shape by cutting an adhesive sheet immediately before bonding. This results in reduced waste production and reduced environmental load.

The UV-curable composition may have any viscosity, and it can be adjusted depending on the application method. For example, when the UV-curable composition is applied by screen printing, the composition is preferably a paste having a viscosity at 25° C. of 5 to 500 Pa·s as measured using an E-type viscometer. The lower limit of the viscosity is more preferably 10 Pa·s, and the upper limit thereof is more preferably 100 Pa·s. Here, the UV-curable composition can be adjusted to a desired viscosity because when a nitrogen-containing monomer is added to increase the reactivity of the UV-curable composition, the composition can react without containing a large amount of a nonreactive component or a high-viscosity crosslinking component.

The viscosity can be measured using VISCOMETER TV-22 (available from Toki Sangyo Co., Ltd.) as an E-type viscometer with a CP1 cone plate by appropriately selecting a rotation rate of 1 to 100 rpm based on an optimal torque for each viscosity range.

The UV-curable composition may be prepared by any method. For example, the UV-curable composition may be prepared by a method of mixing the (meth)acrylate monomer, the crosslinking component, the UV curing agent, and optional additives using a mixing device. Examples of the mixing device include a homogenizing disperser, a homogenizer, a universal mixer, a planetary mixer, a kneader, and a triple roll mill.

The UV-curable composition forms an adhesive layer when cured by UV irradiation. The UV-curable composition may be used for a method of forming an adhesive layer on a substrate (separator) to produce an adhesive sheet transferrable onto an adherend, or a method of forming an adhesive layer directly on an adherend. The method of forming an adhesive layer directly on an adherend can minimize the number of times of bonding and also prevent air bubbles at the interface in bonding. The method of forming an adhesive layer on a substrate (separator) has the advantage of having fewer restrictions on application because the adhesive layer is disposed on an adherend by transfer.

In the following, an adhesive sheet containing the UV-curable composition, a laminate, and a method for producing a laminate are described.

The present invention also encompasses an adhesive sheet including a substrate and an adhesive layer on at least one surface of the substrate, the adhesive layer containing the UV-curable composition of the present invention.

The substrate is not limited, but it is preferably a resin film. Examples of a material of the resin film include polyester polymers such as polyethylene terephthalate and polyethylene naphthalate, cellulose polymers such as diacetyl cellulose and triacetyl cellulose, acrylic polymers such as polymethyl methacrylate, styrene polymers such as polystyrene and acrylonitrile-styrene copolymers (AS resins), and polycarbonate polymers. Examples of a transparent protective film include polyolefin polymers such as polyethylene, polypropylene, polyolefins having a cyclic or norbornene structure, and ethylene-propylene copolymers, vinyl chloride polymers, amide polymers such as nylons and aromatic polyamides, imide polymers, sulfone polymers, polyether sulfone polymers, polyetheretherketone polymers, polyphenylene sulfide polymers, vinyl alcohol polymers, vinylidene chloride polymers, vinyl butyral polymers, acrylate polymers, polyoxymethylene polymers, epoxy polymers, and mixture of these polymers. The substrate may have any thickness and may have a thickness of about 1 to 500 μm, for example.

The substrate is preferably release-treated so that it can be easily removed after the adhesive layer is bonded to an adherend. For example, the substrate is preferably a release-treated polyethylene terephthalate (PET) sheet.

The adhesive layer can be formed by applying the UV-curable composition and then irradiating the composition with UV light. The adhesive layer is preferably disposed on part of the substrate by a method such as printing.

The adhesive layer preferably has a thickness of 30 μm or greater, more preferably 50 μm or greater. The adhesive layer having a thickness of 30 μm or greater can have sufficient adhesion. The upper limit of the thickness of the adhesive layer is not limited. The upper limit is preferably 1,000 μm or less, more preferably 500 μm or less for adaptation to reduced thickness of electronic devices.

With the adhesive sheet, a laminate can be produced by bonding one surface (side not contacting the substrate) of the adhesive layer to a first adherend, then removing the substrate, and bonding the other, exposed surface of the adhesive layer to a second adherend. Examples of materials of the first adherend and the second adherend include metals such as stainless steel and aluminum and resins. The present invention also encompasses a laminate including a first adherend and a second adherend bonded to each other with the adhesive layer of the adhesive sheet of the present invention.

The present invention also encompasses a method for producing a laminate, including: applying the UV-curable composition of the present invention to a first adherend; exposing the UV-curable composition to light to form an adhesive layer; and bonding a second adherend to the adhesive layer to form a laminate. The UV-curable composition is preferably applied by ink-jet printing, screen printing, spray coating, spin coating, gravure offset printing, and reverse offset printing. The UV-curable composition is preferably applied to part of the first adherend.

### Advantageous Effects of Invention

The present invention can provide a UV-curable composition having excellent printability, excellent UV reactivity in the presence of oxygen, and excellent adhesiveness at room temperature and high temperature.

### BRIEF DESCRIPTION OF DRAWINGS

FIG. 1 is a view illustrating a sample production method and measurement targets to illustrate a method for calculating the front surface reaction percentage and the back surface reaction percentage.

FIG. 2 is a view illustrating a method for calculating the front surface reaction percentage and the back surface reaction percentage from obtained IR spectra.

### DESCRIPTION OF EMBODIMENTS

The present invention is described in more detail below with reference to examples. The present invention is not limited to these examples.

### Examples 1 to 17 and Comparative Examples 1 to 7

Materials were mixed using a planetary stirrer (available from Thinky Corporation, “Thinky Mixer”) in accordance with the formulations shown in Tables 1 and 2 to provide UV-curable compositions of examples and comparative examples.

The following are the details of the materials expressed in abbreviations in the tables.
Viscoat #150D: tetrahydrofurfuryl alcohol acrylic acid multimer ester (available from Osaka Organic Chemical Industry Ltd.)
LA: lauryl acrylate (available from Osaka Organic Chemical Industry Ltd.)
IBOA: isobornyl acrylate (available from Nippon Shokubai Co., Ltd.)
INAA: isononyl acrylate (available from Osaka Organic Chemical Industry Ltd.)
Viscoat #190; CBA: ethyl carbitol acrylate (available from Osaka Organic Chemical Industry Ltd.)
2-EHA: acrylic acid-2-ethylhexyl (available from Nippon Shokubai Co., Ltd.)
WAKA: heptyl acrylate (available from Osaka Organic Chemical Industry Ltd.)
IDAA: isodecyl acrylate (available from Osaka Organic Chemical Industry Ltd.)
Macromonomer AB-6 (available from Toagosei Co., Ltd.)
CN9004: urethane (bifunctional, available from Sartomer Japan Inc., “CN9004”)
200PA: polyester urethane acrylate (available from Shin-Nakamura Chemical Co., Ltd., “U-200PA”)
DMAA: dimethylacrylamide (available from KJ Chemicals Corporation)
Acrylic Ester HH: 2-methacryloyloxyethyl hexahydrophthalate (available from Mitsubishi Chemical Corporation)
4HBA: 4-hydroxybutyl acrylate (available from Mitsubishi Chemical Corporation)
MILLIONATE MR: polymeric MDI (available from Tosoh Corporation)
NVC: N-vinyl-ε-caprolactam (available from Tokyo Chemical Industry Co., Ltd.)
NVA: N-vinylacetamide (available from Showa Denko K.K.)
PVB: BM-2 (available from Sekisui Chemical Co., Ltd.)
T0125: terpene resin (available from Yasuhara Chemical Co., Ltd.)
KS-66: oil compound defoamer containing silicone oil compounded with silica fine powder (available from Shin-Etsu Silicones, “KS-66”)
Omnirad 819: Omnirad 819 (available from IGM Resins B.V)
Omnirad 184: Omnirad 184 (available from IGM Resins B.V)
Omnirad TPO H: Omnirad TPO H (available from IGM Resins B.V)

The acrylic polymers used as thermoplastic resins in the examples and the comparative examples were prepared as follows.

### (Acrylic Polymer A)

A 2-L separable flask equipped with a thermometer, a stirrer, a nitrogen inlet tube, and a condenser was charged with 100 parts by weight of 2-ethylhexyl acrylate, 3 parts by weight of acrylic acid, 0.1 parts by weight of 2-hydroxyethyl acrylate, and 300 parts by weight of ethyl acetate as a polymerization solvent. Subsequently, nitrogen gas was blown into the reaction vessel for 30 minutes so that the air inside was purged with nitrogen, and the contents of the reaction vessel were heated to 80° C. with stirring. After 30 minutes, 0.5 parts by weight of t-butylperoxy-2-ethylhexanoate (one-hour half life temperature: 92.1° C., ten-hour half-life temperature: 72.1° C.) as a polymerization initiator was diluted with 5 parts by weight of ethyl acetate, and the obtained polymerization initiator solution was dripped into the reaction vessel over six hours. Thereafter, the reaction was further continued at 80° C. for six hours, and then the reaction solution was cooled to provide an acrylic polymer solution.

The obtained solution was diluted with a diluting solvent (solvent mixture of methanol and toluene, with a methanol/toluene weight ratio of 1:2) to provide a solution having a solid content of 20% by weight. Subsequently, this solution was applied to a release-treated PET film to a dried thickness of 100 μm with a coater, and dried at 80° C. for one hour and at 110° C. for one hour, whereby an acrylic polymer A was obtained.

### (Acrylic Polymer B)

A 2-L separable flask was charged with 120 g of 4-HBA and 1 g of lauryl mercaptan (available from FUJIFILM Wako Pure Chemical Corporation). To the 2-L separable flask was added 0.6 ppm of 2,2′-azobis(2-methylbutyronitrile) (available from FUJIFILM Wako Pure Chemical Corporation, “V-59”) as a thermal polymerization initiator. Next, the contents of the separable flask were bubbled with nitrogen at a flow rate of 0.5 L/min for 30 minutes to allow nitrogen to flow in the flask. After 30 minutes, the flow rate of the nitrogen flow was decreased to 0.2 L/min, and the solution was heated to 60° C. in a water bath. The polymerization reaction started, and when the viscosity reached 20 cps, the separable flask was taken out from the water bath and cooled to stop the polymerization reaction. This produced a composition containing a (meth)acrylate monomer and a (meth)acrylic polymer. To the composition containing the (meth)acrylate monomer and the (meth)acrylic polymer was further added 4-HBA to adjust the viscosity to 5.5 cps, whereby an acrylic polymer B was obtained. The acrylic polymer B and tetrahydrofuran (THF) were weighed into an aluminum pan such that the amount of the acrylic polymer B was 1 part by weight relative to 100 parts by weight of THF. They were dried in an oven at 140° C. to measure the weight solid concentration of the (meth)acrylic polymer in the composition. The solid concentration was 60% by weight.

### (Acrylic Polymer C)

A 2-L separable flask equipped with a thermometer, a stirrer, a nitrogen inlet tube, and a condenser was charged with 100 parts by weight of isooctyl acrylate (available from Sigma-Aldrich Japan), 50 parts by weight of isobornyl acrylate, 10 parts by weight of benzyl acrylate (available from Osaka Organic Chemical Industry Ltd.), 300 parts by weight of ethyl acetate as a polymerization solvent, and 0.1 and parts by weight of lauryl mercaptan. Subsequently, nitrogen gas was blown into the reaction vessel for 30 minutes so that the air inside was purged with nitrogen, and the contents of the reaction vessel were heated to 80° C. with stirring. After 30 minutes, 0.5 parts by weight of t-butylperoxy-2-ethylhexanoate (one-hour half life temperature: 92.1° C., ten-hour half-life temperature: 72.1° C.) as a polymerization initiator was diluted with 5 parts by weight of ethyl acetate, and the obtained polymerization initiator solution was dripped into the reaction vessel over six hours. Thereafter, the reaction was further continued at 80° C. for six hours, and then the reaction solution was cooled to provide an acrylic polymer solution.

The obtained solution was diluted with a diluting solvent (solvent mixture of methanol and toluene, with a methanol/toluene weight ratio of 1:2) to provide a solution having a solid content of 20% by weight. Subsequently, this solution was applied to a release-treated PET film to a dried thickness of 100 μm with a coater, and dried at 80° C. for one hour and at 110° C. for one hour, whereby an acrylic polymer C was obtained.

### <Evaluation>

The UV-curable compositions of Examples 1 to 17 and Comparative Examples 1 to 7 and cured products of the compositions were evaluated as follows. Tables 1 to 3 show the results.

The cured products used for evaluation were produced as follows.

### (Production of Cured Product)

The UV-curable compositions were each applied with an applicator to a thickness of 150 μm to a PET sheet having one release-treated surface (available from Nippa Corporation, “1-E”, thickness 50 μm). Subsequently, without sealing the upper surface of the applied composition, the composition was irradiated with UV light with an irradiation energy of 1,350 mJ/cm² in an atmospheric environment using a batch-type UV LED curing device (available from Aitec System Co., Ltd., “M UVBA”) set to a UV irradiance of 30 mW/cm² at a wavelength of 365 nm and a UV irradiance of 60 mW/cm² at a wavelength of 405 nm. The UV-curable composition was thereby cured to provide a cured product.

### (Homopolymer Tg)

Each (meth)acrylate monomer (100 parts by weight) was stirred and mixed with 0.2 parts by weight of a photopolymerization initiator using a planetary stirrer (available from Thinky Corporation, “Thinky Mixer”) to provide a photopolymerizable composition. The obtained photopolymerizable composition was formed into a photopolymerizable composition layer having a thickness of 100 μm between two PET sheets each having one release-treated surface (available from Nippa Corporation, “1-E”, thickness 50 μm). Here, a spacer having a thickness of 100 μm was placed at the peripheries of the two PET sheets.

The photopolymerizable composition layer was irradiated with UV light with an irradiation energy of 1,350 mJ/cm² using a batch-type UV LED curing device (available from Aitec System Co., Ltd., “M UVBA”) set to a UV irradiance of 30 mW/cm² at a wavelength of 365 nm and a UV irradiance of 60 mW/cm² at a wavelength of 405 nm. The photopolymerizable composition layer was thereby cured to provide a homopolymer cured product.

The viscoelasticity of the obtained homopolymer cured product was measured with a viscoelastometer (available from TA Instruments, “ARES-G2”). Parallel plates with a diameter of 8 mm were used as jigs. The viscoelasticity was measured in a shear mode under the conditions of raising the temperature from −100° C. to 200° C. at a temperature increase rate of 3° C./min with a frequency of 1 Hz and a strain of 0.1%. In the obtained measurement results, the loss tangent peak temperature was defined as the glass transition temperature Tg (° C.).

### (Gel Fraction)

The cured product (0.15 g) produced as above was immersed in 30 g of tetrahydrofuran and immersed with shaking at 23° C. for 36 hours. Subsequently, the cured product was recovered through a 200-mesh filter and then dried by heating at 110° C. for one hour. The weight of the cured product was then measured. The gel fraction was calculated by the following formula (X).

Gel fraction (% by weight)=W2/W1×100 Formula (X)
W1: Weight of cured product before being immersed in tetrahydrofuran at 23° C.
W2: Weight of cured product after being immersed in tetrahydrofuran at 23° C., recovered, and dried

The gel fraction of the homopolymer cured product was also measured in the same manner.

### (Tg)

The cured product produced as above was subjected to measurement using a dynamic viscoelastometer (available from IT Keisoku Seigyo Co., Ltd., “DVA-200”) under the following conditions. The tan δ peak temperature was defined as Tg.

### [Measurement Conditions]

### Shear Method

Measurement temperature: −100° C. to 200° C.
Temperature increase rate: 3° C./min
Strain: 0.1%
Frequency: 1 Hz

### (Reaction Percentage)

About 0.3 g of the cured product produced as above was placed in an aluminum pan, to which a solvent mixture containing THF, acetone, and ethanol at a THF:acetone:ethanol weight ratio of 8:1:1 was added slowly without splashing the cured product sample, and the sample was left to swell for about two hours. This was followed by drying at 110° C. for 30 minutes, at 170° C. for one hour, and at 190° C. for 30 minutes. After drying, it was confirmed that the mixed solvent had completely evaporated. The aluminum pan after drying and the dried sample were then weighed. The reaction percentage was calculated by the following formula.

Reaction percentage [%]=100−(Total weight of aluminum pan and sample after drying−Weight of aluminum pan before drying)/(Total weight of aluminum pan and sample before drying−Weight of aluminum pan before drying)×100

### (Front Surface Reaction Percentage, Back Surface Reaction Percentage, and Reaction Progress Percentage)

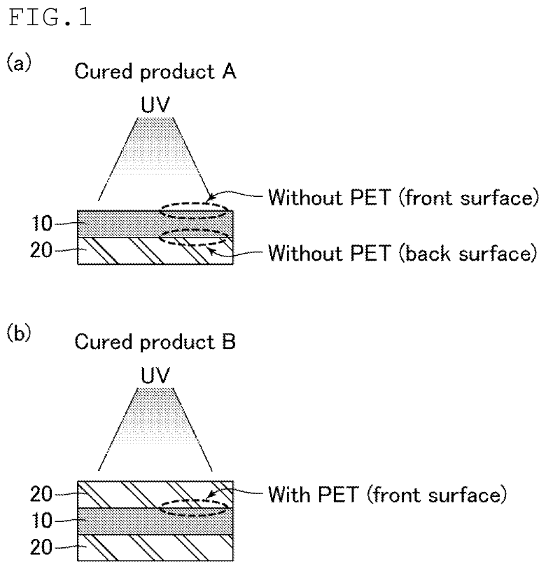

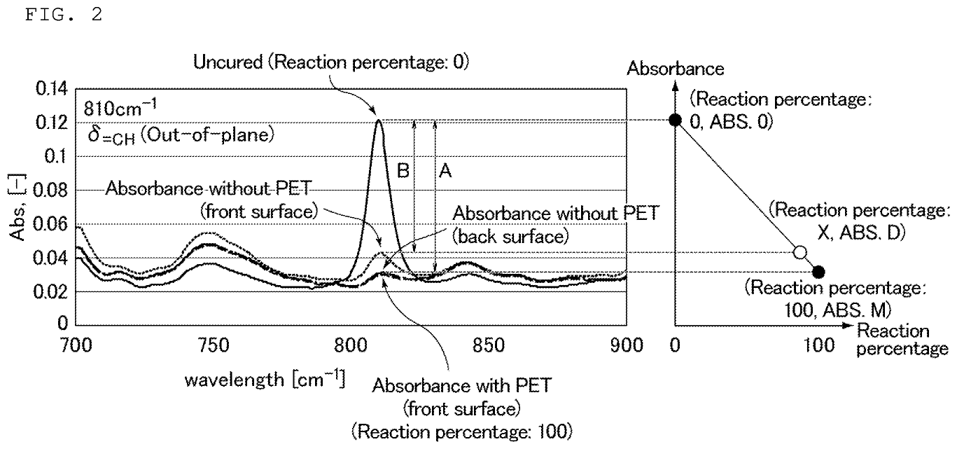

FIGS. 1 and 2 are views for illustrating a method for calculating the front surface reaction percentage and the back surface reaction percentage. FIG. 1 illustrates a sample preparation method and measurement targets. FIG. 2 illustrates a method for calculating the front surface reaction percentage and the back surface reaction percentage from obtained IR spectra. A sample of the cured product produced as above (cured in an atmospheric environment without sealing the upper surface of the applied composition; see FIG. 1(a)) was defined as a “cured product A”. Another sample was produced by UV light (UV) irradiation in the same manner as for the cured product A, except that a UV-curable composition 10 was interposed between PET sheets 20 (see FIG. 1(b)). This sample was defined as a “cured product B”.

First, the front and back surfaces of the cured product A were subjected to measurement of IR spectra (infrared absorption spectra) as shown in FIG. 2 by the ATR method using a Fourier transform infrared spectrometer (Nicolet iS5 FT-IR), and the absorbance values at 810 cm⁻¹ were obtained. The obtained value of the front surface and the obtained value of the back surface were defined as “Absorbance without PET (front surface)” and “Absorbance without PET (back surface)”, respectively.

Further, the PET sheet was removed from the irradiated surface (front surface) of the cured product B during curing. The surface (front surface) was then subjected to measurement of an IR spectrum as shown in FIG. 2 in the same manner by the ATR method, and the absorbance value at 810 cm-1 was obtained. The obtained value was defined as “Absorbance with PET (front surface)”.

From these values and the reaction percentage above, the front surface reaction percentage, the back surface reaction percentage, and the reaction progress percentage were calculated by the following formulas.

Front surface reaction percentage [%]=Reaction percentage [%]×Absorbance without PET (front surface)/Absorbance with PET (front surface)

Back surface reaction percentage [%]=Reaction percentage [%]×Absorbance without PET (back surface)/Absorbance with PET (front surface)

Reaction progress percentage [%]=Front surface reaction percentage [%]/Back surface reaction percentage [%]×100

The “Absorbance without PET (front surface)/Absorbance with PET (front surface)” and the “Absorbance without PET (back surface)/Absorbance with PET (front surface)” mean the percentage values of the “Absorbance without PET (front surface)” and the “Absorbance without PET (back surface)”, with the absorbance at 810 cm⁻¹ measured on the uncured UV-curable composition taken as 0% (minimum) and the “Absorbance with PET (front surface)” as 100% (maximum). For example, the “Absorbance without PET (front surface)/Absorbance with PET (front surface)” means Reaction percentage X in FIG. 2 and is represented by the following formula.

$$Reaction percentage X = B / A$$

$$A = \vert ABS . M - ABS \text{.0} \vert$$

$$B = \vert ABS . D - ABS \text{.0} \vert$$

### (Low-Temperature Tan δ)

In the Tg evaluation above, the tan δ value at −17° C. was determined.

### (Adhesive Force: Peel Test)

The cured product produced as above was cut to a width of 125 mm and a length of 125 mm and transferred onto the inner treated surface of an easy adhesion polyester film (“COSMOSHINE A4100”, available from Toyobo Co., Ltd.) such that the unsealed surface contacted the inner treated surface. The workpiece was cut to five specimens each having a width of 25 mm and a length of 200 mm (surface to be bonded 125 mm). Subsequently, the PET sheet opposite to the transfer surface was removed from each specimen. Each specimen was bonded to a SUS 304-BA substrate (80 mm×125 mm×1 mmt) and pressure-bonded by moving a 2-kg roller back and forth once thereon. The pressure-bonded specimen was subjected to 1800 peeling at a speed of 300 mm/min using a universal tester (available from A AND D Company, Ltd., “TENSILON RTI-1310”), and the adhesive force was determined (integrated average-equivalent load). High-temperature evaluation at 60° C. and 115° C. was performed in a chamber using a thermostat chamber (available from Mita Sangyo K.K.).

### (Shock Absorption)

A SUS substrate (40 mm×40 mm×3 mmt) having a hole (20 mm×20 mm×3 mmt) on its center was bonded to a SUS substrate (25 mm×25 mm×3 mmt) with a cut piece of the cured product with a size of 25 mm×25 mm (width 1.5 mm). The substrates were pressure-bonded at 62 N using a universal tester (available from A AND D, “TENSILON RTI-1310”) to provide a specimen. Using a drop weight impact tester (IM1C-15 model) available from Imatek Systems Limited, a drop weight (16Φ) was allowed to freely fall at 2 m/s from a height of 233 mm to impact the center portion of the specimen. From the obtained spectrum with the time (unit [ms]) on the horizontal axis and the impact load (unit [N]) on the vertical axis, the energy amount (area=shock absorption [J]) of the first peak was calculated, thereby the shock absorption was obtained. A shock absorption of 0.2 J or higher is favorable.

### (Printability)

### [Screen Printing]

The UV-curable compositions were each evaluated for screen printability using a screen printer (“SSA-PC560E”, available from Seria Corporation). The UV-curable compositions were each applied to a PET sheet (available from Nippa Corporation “1-E”, thickness 50 μm) to form a pattern using a patterned 70-mesh printing plate as a screen-printing plate. The compositions were observed for stringing upon separation from the screen-printing plate and the leveling and defoaming of the printed matter. A composition with no stringing and very good leveling and defoaming was evaluated as “oo” (Excellent). A composition with no stringing and good leveling and defoaming was evaluated “o” (Good). A composition with no stringing but with a slightly rough printing surface or failure of defoaming was evaluated as “A” (Fair). A composition causing stringing upon separation from the plate was evaluated as “x” (Poor).

### [Ink-Jet Printing]

The UV-curable compositions (0.5 mL) were each dripped onto an aluminum substrate (50 mm×50 mm) and applied with a spin coater (available from Mikasa Co., Ltd., “MSB-150”) at a rotation rate of 5,000 rpm for 10 seconds to form a thin layer. The obtained thin layer was cured by irradiation with UV light with an irradiation energy of 200 mJ/cm² using a LED UV irradiator (available from Integration Technology, Solidcure 2) set at a UV irradiance of 1,000 mW/cm² at a wavelength of 365 nm. The thin layer obtained after curing was evaluated in accordance with the following criteria.
∘∘ (Excellent): The thin layer had no liquid feel, was sufficiently cured, and had a tacky feel.
∘(Good): The thin layer had no liquid feel but had no tacky feel.
x (Poor): The thin layer had a liquid feel and was insufficiently cured.

TABLE 1

| | | Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| (Meth)acrylate | Viscoat #150D | 7.6 | 7.8 | 7.2 | 5.7 | — | — | — | — | — | — | 3.0 |
| | LA | — | — | — | — | — | — | — | — | — | — | — |
| | IBOA | — | — | — | — | — | — | — | — | — | — | — |
| | INAA | — | 26.1 | 24.0 | 39.0 | — | — | — | — | — | — | — |
| | Viscoat #190; CBA | — | 26.1 | 24.1 | 10.9 | 66.3 | 64.1 | 56.6 | 75.9 | 74.0 | 75.9 | — |
| | 2-EHA | — | — | — | — | — | — | — | — | — | — | — |
| | WAKA | — | — | — | — | — | — | — | — | — | — | — |
| | IDAA | 50.6 | — | — | — | — | — | — | — | — | — | 60.0 |
| | Macromonomer AB-6 | — | 14.1 | 13.0 | 12.5 | 10.6 | 12.8 | 20.4 | — | — | — | — |
| | CN9004 | 1.2 | 1.2 | 1.1 | 1.8 | — | — | — | 1.1 | 3.0 | — | 4.0 |
| | 200PA | — | — | — | — | — | — | — | — | — | 1.1 | — |
| | DMAA | — | — | — | — | — | — | — | — | — | — | 30.0 |
| | Acrylic Ester HH | — | — | — | — | — | — | — | — | — | — | — |
| | 4HBA | 7.6 | 7.9 | 7.2 | 5.8 | — | — | — | — | — | — | 3.0 |
| Isocyanate | MILLIONATE MR | — | — | — | — | — | — | — | — | — | — | — |
| Nitrogen-containing | NVC | 32.9 | 16.9 | 23.3 | 24.4 | 23.1 | 23.1 | 23.1 | 23.1 | 23.1 | 23.1 | — |
| monomer | NVA | — | — | — | — | — | — | — | — | — | — | — |
| Thermoplastic resin | Acrylic polymer A | 24.7 | — | — | — | — | — | — | — | 4.0 | — | 30.0 |
| | Acrylic polymer B | — | — | — | — | — | — | — | — | — | — | — |
| | Acrylic polymer C | — | — | — | — | — | — | — | — | — | — | — |
| | PVB | — | — | — | — | — | — | — | — | — | — | — |
| Tackifier | TO125 | — | — | — | — | — | — | — | — | — | — | — |
| Defoamer | KS-66 | — | — | — | — | — | — | — | — | — | — | — |
| UV curing agent | Omnirad 819 | — | 0.5 | 0.5 | 0.5 | 0.5 | 0.5 | 0.5 | 0.5 | 0.5 | 0.5 | 0.5 |
| | Omnirad 184 | — | 0.5 | 0.5 | 0.5 | 0.5 | 0.5 | 0.5 | 0.5 | 0.5 | 0.5 | 0.5 |
| | Omnirad TPO H | 0.5 | 0.5 | 0.5 | 0.5 | 0.5 | 0.5 | 0.5 | 0.5 | 0.5 | 0.5 | 0.5 |
| Amount of monomer with Tg −70 to −30° C. (% by | | 51.9 | 67.4 | 62.2 | 64.2 | 76.9 | 76.9 | 76.9 | 76.9 | 76.9 | 75.9 | 64.0 |
| weight) | | | | | | | | | | | | |
| Thermoplastic resin and tackifier (parts by weight) | | 24.7 | 0.0 | 0.0 | 0.0 | 0.0 | 0.0 | 0.0 | 0.0 | 4.0 | 0.0 | 30.0 |
| (Meth)acrylate monomer with viscosity at 25° C. of | | 1.2 | 15.3 | 14.1 | 14.3 | 10.6 | 12.8 | 20.4 | 1.1 | 3.0 | 1.1 | 4.0 |
| 10000 cps or higher (% by weight) | | | | | | | | | | | | |
| Gel fraction (%) | | 17.5 | 54.8 | 61.4 | 67.2 | 20.2 | 35.3 | 45.0 | 42.1 | 68.6 | 40.2 | 42.6 |
| Tg of cured product (° C.) | | 0.2 | −16.8 | −7.5 | 0.3 | −18.7 | −17.6 | −15.5 | −21.8 | −19.3 | −19.7 | −24.9 |
| Reaction percentage (%) | | 98.2 | 94.6 | 95.3 | 97.2 | 96.0 | 95.7 | 96.2 | 95.7 | 96.3 | 95.7 | 87.6 |
| Front surface reaction percentage (%) | | 98.2 | 85.0 | 92.3 | 93.6 | 91.8 | 90.3 | 91.9 | 91.5 | 91.5 | 90.8 | 94.3 |
| Back surface reaction percentage (%) | | 103.3 | 88.8 | 98.0 | 96.7 | 96.7 | 94.5 | 96.3 | 96.3 | 95.4 | 95.4 | 95.5 |
| Reaction progress percentage (%) | | 95.1 | 95.7 | 94.1 | 96.8 | 95.0 | 95.6 | 95.4 | 95.0 | 95.9 | 95.1 | 98.7 |
| tan δ (at −17° C.) | | 0.8 | 1.8 | 0.9 | 0.4 | 1.9 | 1.9 | 1.9 | 1.6 | 1.8 | 2.0 | 2.5 |
| Adhesive force at 23° C. | (N/cm) | 4.6 | 6.0 | 5.7 | 8.6 | 16.1 | 9.1 | 4.1 | 15.7 | 5.8 | 10.7 | 10.7 |
| Adhesive force at 60° C. | (N/cm) | 3.1 | 3.9 | 4.0 | 4.5 | 3.9 | 4.5 | 4.5 | 3.1 | 4.9 | 3.9 | 5.3 |
| Adhesive force at 115° C. | (N/cm) | 0.5 | 0.7 | 0.7 | 0.8 | 0.7 | 0.4 | 0.3 | 0.5 | 0.4 | 0.7 | 0.7 |
| Shock absorption | ΔE | 0.3 | 0.3 | 0.2 | 0.2 | 0.4 | 0.5 | 0.2 | 0.5 | 0.3 | 0.4 | 0.4 |
| Printability | Printing method | Screen | Inkjet | Inkjet | Inkjet | Inkjet | Inkjet | Inkjet | Inkjet | Inkjet | Inkjet | Screen |
| | Evaluation | ∘∘ | ∘∘ | ∘∘ | ∘∘ | ∘∘ | ∘∘ | ∘∘ | ∘∘ | ∘∘ | ∘∘ | ∘ |

TABLE 2

| | | Example | | | | | | Comparative Example | |
|---|---|---|---|---|---|---|---|---|---|
| | | 12 | 13 | 14 | 15 | 16 | 17 | 1 | 2 |
| (Meth)acrylate | Viscoat #150D | — | — | — | — | — | — | — | — |
| | LA | — | — | — | — | — | — | — | — |
| | IBOA | — | — | — | — | — | — | — | — |
| | INAA | 37.9 | 30.0 | — | — | 67.0 | 85.0 | — | — |
| | Viscoat #190; CBA | 37.9 | 50.0 | — | 84.0 | — | — | 67.8 | — |
| | 2-EHA | — | — | — | — | — | — | — | — |
| | WAKA | — | — | 67.0 | — | — | — | — | — |
| | IDAA | — | — | — | — | — | — | — | — |
| | Macromonomer AB-6 | — | — | — | 15.0 | — | 20.0 | — | — |
| | CN9004 | 1.5 | — | 5.0 | 5.0 | 5.0 | 5.0 | — | — |
| | 200PA | — | — | — | — | — | — | 9.1 | — |
| | DMAA | — | — | — | — | — | — | — | — |
| | Acrylic Ester HH | — | 10.0 | — | — | — | — | — | — |
| | 4HBA | — | 10.0 | 3.0 | — | 3.0 | — | — | 100.0 |
| Isocyanate | MILLIONATE MR | — | 2.4 | — | — | — | — | — | — |
| Nitrogen-containing | NVC | 22.7 | — | 25.0 | — | 25.0 | 15.0 | 23.1 | — |
| monomer | NVA | — | — | — | 15.0 | — | — | — | — |
| Thermoplastic resin | Acrylic polymer A | 15.2 | — | 25.0 | 20.0 | 25.0 | 40.0 | — | — |
| | Acrylic polymer B | — | 20.0 | — | — | — | — | — | 150.0 |
| | Acrylic polymer C | — | — | — | — | — | — | — | — |
| | PVB | — | — | — | — | — | — | — | — |
| Tackifier | TO125 | 11.4 | 15.0 | — | 10.0 | — | — | — | — |
| Defoamer | KS-66 | — | — | — | — | 1.2 | — | — | — |
| UV curing agent | Omnirad 819 | 0.5 | 0.5 | 0.5 | 0.5 | 0.5 | — | 0.5 | — |
| | Omnirad 184 | 0.5 | 0.5 | 0.5 | 0.5 | 0.5 | — | 0.5 | — |
| | Omnirad TPO H | 0.5 | 0.6 | 0.6 | 0.6 | 0.6 | 0.5 | 0.5 | — |
| Amount of monomer with Tg −70 to −30° C. (% by | | 77.3 | 78.1 | 72.0 | 87.4 | 72.0 | 88.0 | 67.8 | 0.0 |
| weight) | | | | | | | | | |
| Thermoplastic resin and tackifier (parts by weight) | | 26.5 | 34.2 | 25.0 | 25.2 | 25.0 | 32.0 | 0.0 | 150.0 |
| (Meth)acrylate monomer with viscosity at 25° C. of | | 1.5 | 0.0 | 5.0 | 16.8 | 5.0 | 20.0 | 9.1 | 0.0 |
| 10000 cps or higher | | | | | | | | | |
| Gel fraction (%) | | 24.3 | 54.2 | 48.1 | 70.5 | 42.5 | 0.7 | 91.1 | 80.8 |
| Tg of cured product (° C.) | | −19.5 | −34.3 | −16.8 | −20.3 | −14.2 | −28.1 | −16.1 | −19.8 |
| Reaction percentage (%) | | 99.2 | 84.9 | 90.0 | 90.5 | 91.3 | 84.1 | 93.4 | 94.5 |
| Front surface reaction percentage (%) | | 95.2 | 88.3 | 98.5 | 86.5 | 94.2 | 87.1 | 92.3 | 97.8 |
| Back surface reaction percentage (%) | | 98.2 | 84.2 | 97.2 | 92.7 | 98.1 | 91.2 | 95.2 | 93.1 |
| Reaction progress percentage (%) | | 96.9 | 104.8 | 101.4 | 93.4 | 96.0 | 95.5 | 97.0 | 105.1 |
| tan δ (at −17° C.) | | 2.8 | 0.5 | 1.1 | 1.5 | 1.5 | 1.5 | 1.8 | 2.0 |
| Adhesive force at 23° C. | (N/cm) | 12.5 | 14.3 | 15.2 | 8.1 | 13.8 | 6.8 | 1.9 | 4.1 |
| Adhesive force at 60° C. | (N/cm) | 6.5 | 6.2 | 7.5 | 6.1 | 7.0 | 3.8 | 1.3 | 0.1 |
| Adhesive force at 115° C. | (N/cm) | 1.3 | 2.1 | 1.3 | 3.0 | 1.3 | 0.5 | 0.5 | −0.1 |
| Shock absorption | ΔE | 0.7 | 0.3 | 0.7 | 0.3 | 0.5 | 0.3 | 0.2 | 0.2 |
| Printability | Printing method | Screen | Screen | Screen | Screen | Screen | Screen | Inkjet | Screen |
| | Evaluation | ∘∘ | ∘∘ | ∘∘ | ∘∘ | ∘∘ | ∘ | ∘∘ | Δ |

| | | Comparative Example | | | | |
|---|---|---|---|---|---|---|
| | | 3 | 4 | 5 | 6 | 7 |
| (Meth)acrylate | Viscoat #150D | — | 12.2 | — | 62.5 | — |
| | LA | — | — | 45.7 | — | — |
| | IBOA | 15.2 | — | — | — | — |
| | INAA | 84.8 | — | — | — | — |
| | Viscoat #190; CBA | — | — | — | — | 90.0 |
| | 2-EHA | — | — | 10.6 | — | — |
| | WAKA | — | — | — | — | — |
| | IDAA | — | 75.5 | — | — | — |
| | Macromonomer AB-6 | — | — | — | — | — |
| | CN9004 | — | 1.0 | 38.8 | — | 5.0 |
| | 200PA | — | — | — | — | — |
| | DMAA | — | — | — | — | — |
| | Acrylic Ester HH | — | — | 4.9 | 37.5 | — |
| | 4HBA | — | 11.3 | — | — | — |
| Isocyanate | MILLIONATE MR | — | — | — | — | — |
| Nitrogen-containing | NVC | — | — | — | — | 5.0 |
| monomer | NVA | — | — | — | — | — |
| Thermoplastic resin | Acrylic polymer A | — | 20.2 | — | — | 20.0 |
| | Acrylic polymer B | — | — | — | — | — |
| | Acrylic polymer C | 101.2 | — | — | — | — |
| | PVB | — | — | — | — | — |
| Tackifier | TO125 | 92.4 | — | 24.8 | — | 10.0 |
| Defoamer | KS-66 | — | — | — | — | — |
| UV curing agent | Omnirad 819 | — | — | — | 0.3 | 0.5 |
| | Omnirad 184 | 2.3 | — | 2.3 | 0.1 | 0.5 |
| | Omnirad TPO H | 0.8 | — | 0.8 | — | 0.5 |
| Amount of monomer with Tg −70 to −30° C. (% by | | 84.8 | 76.5 | 49.4 | 0.0 | 95.0 |
| weight) | | | | | | |
| Thermoplastic resin and tackifier (parts by weight) | | 193.6 | 20.2 | 24.8 | 0.0 | 30.0 |
| (Meth)acrylate monomer with viscosity at 25° C. of | | 0.0 | 1.0 | 38.8 | 0.0 | 5.0 |
| 10000 cps or higher | | | | | | |
| Gel fraction (%) | | 35.5 | 42.6 | 69.4 | 2.9 | 15.2 |
| Tg of cured product (° C.) | | −17.8 | −19.6 | −24.6 | 15.4 | −34.2 |
| Reaction percentage (%) | | 82.7 | 81.5 | 85.9 | 91.3 | 72.2 |
| Front surface reaction percentage (%) | | 77.3 | 77.5 | 81.2 | 95.3 | 65.2 |
| Back surface reaction percentage (%) | | 84.5 | 71.2 | 92.2 | 89.2 | 84.5 |
| Reaction progress percentage (%) | | 91.5 | 109.0 | 88.1 | 106.7 | 77.2 |
| tan δ (at −17° C.) | | 1.9 | 1.9 | 1.9 | 0.3 | 2.2 |
| Adhesive force at 23° C. | (N/cm) | 3.7 | 8.5 | 4.6 | 0.9 | 1.8 |
| Adhesive force at 60° C. | (N/cm) | 0.0 | 2.1 | 1.2 | 0.9 | 0.1 |
| Adhesive force at 115° C. | (N/cm) | 0.0 | 0.1 | 0.2 | 1.3 | 0.0 |
| Shock absorption | ΔE | 0.1 | 0.3 | 0.5 | 0.0 | 0.2 |
| Printability | Printing method | Screen | Screen | Screen | Inkjet | Screen |
| | Evaluation | x | x | ∘ | ∘ | ∘ |

TABLE 3

| | Tg of | | Homopolymer | (Meth)acrylate monomer |
|---|---|---|---|---|
| | homopolymer | Gel fraction of | has gel fraction | with viscosity at 25° C. |
| | (° C.) | homopolymer (%) | of 80% or higher | of 10000 cps or higher |
| Viscoat #150D | −8.7 | 19.92 | No | No |
| LA | 0.5 | 0.55 | | |
| IBOA | 74.0 | 0.25 | | |
| INAA | −43.6 | 1.00 | | |
| Viscoat #190; CBA | −43.5 | 0.98 | | |
| 2-EHA | −41.8 | 0.41 | | |
| WAKA | −43.7 | 0.25 | | |
| IDAA | −37.6 | 0.50 | | |
| Macromonomer AB-6 | −37.9 | 0.99 | | Yes |
| CN9004 | −67.5 | 81.14 | Yes | |
| 200PA | −2.7 | 95.85 | | |
| DMAA | 90.4 | 85.33 | | No |
| Acrylic Ester HH | 74.0 | 89.45 | | |
| 4HBA | −16.7 | 94.61 | | |

### INDUSTRIAL APPLICABILITY

The present invention can provide a UV-curable composition having excellent printability, excellent UV reactivity in the presence of oxygen, and excellent adhesiveness at room temperature and high temperature.

### REFERENCE SIGNS LIST

10: UV-curable composition
20: PET sheet

1. A UV-curable composition comprising:
a curing component containing a (meth)acrylate monomer and a crosslinking component; and
a UV curing agent,
the (meth)acrylate monomer including, in 100% by weight of the curing component, 50 to 85% by weight of a monomer that, in a form of a homopolymer, has a glass transition temperature of −70° C. to −30° C.,
a cured product being obtained by applying the composition to a substrate at a thickness of 150 m and irradiating the composition, without sealing an upper surface of the applied composition, with UV light having a wavelength of 315 nm to 480 nm at an irradiance of 90 mW/cm² and a dose of 1,350 mJ/cm² in an atmospheric environment,
the cured product having a gel fraction of 0.4 to 78%, a glass transition temperature of −35° C. to 10° C., a reaction percentage of 83% or higher, and a reaction progress percentage on a surface facing the atmosphere of 93% or higher relative to a surface facing the substrate.

2. The UV-curable composition according to claim 1, further comprising a nonreactive component having no reactivity with the curing component.

3. The UV-curable composition according to claim 2,
wherein the nonreactive component is contained at a ratio of 0.1 to 140 parts by weight relative to 100 parts by weight of the curing component.

4. The UV-curable composition according to claim 2,
wherein the nonreactive component contains at least one of a thermoplastic resin or a tackifier.

5. The UV-curable composition according to claim 1,
wherein the cured product has a reaction percentage of 80% or higher on both of the surface facing the atmosphere and the surface facing the substrate.

6. The UV-curable composition according to claim 2,
the crosslinking component has reactivity with the curing component or has reactivity with the curing component and the nonreactive component.

7. The UV-curable composition according to claim 1,
wherein the crosslinking component has at least one binding functional group selected from the group consisting of an isocyanate group, an epoxy group, an aldehyde group, a hydroxy group, an amino group, a (meth)acrylate group, and a vinyl group.

8. The UV-curable composition according to claim 1,
wherein the crosslinking component contains a (meth)acrylate monomer that, in a form of a homopolymer, has a gel fraction of 80% or higher.

9. The UV-curable composition according to claim 1,
wherein the crosslinking component is a (meth)acrylate monomer having a viscosity at 25° C. of 10,000 cps or higher and is contained in an amount of 0.1 to 25% by weight in 100% by weight of the curing component.

10. The UV-curable composition according to claim 1,
wherein the UV curing agent is contained in an amount of 0.2 to 10 parts by weight relative to 100 parts by weight of the curing component.

11. The UV-curable composition according to claim 10,
wherein the UV curing agent is contained in an amount of 0.4 to 5 parts by weight relative to 100 parts by weight of the curing component.

12. The UV-curable composition according to claim 1,
wherein the curing component contains a nitrogen-containing monomer.

13. The UV-curable composition according to claim 12,
wherein the nitrogen-containing monomer is contained in an amount of 5 to 33% by weight in 100% by weight of the curing component.

14. The UV-curable composition according to claim 12,
wherein the nitrogen-containing monomer includes a monomer having a lactam structure.

15. The UV-curable composition according to claim 1,
wherein the cured product has a gel fraction of 15 to 67%.

16. The UV-curable composition according to claim 1, which is a UV-curable composition for printing.

17. The UV-curable composition according to claim 16, which is used for screen printing or ink-jet printing.

18. An adhesive sheet comprising:
a substrate; and
an adhesive layer on at least one surface of the substrate, the adhesive layer containing the UV-curable composition according to claim 1.

19. The adhesive sheet according to claim 18,
wherein the adhesive layer is disposed on part of the substrate.

20. A laminate comprising a first adherend and a second adherend bonded to each other with the adhesive layer of the adhesive sheet according to claim 18.

21. A method for producing a laminate, comprising:
applying the UV-curable composition according to claim 17 to a first adherend;
exposing the UV-curable composition to light to form an adhesive layer; and
bonding a second adherend to the adhesive layer to form a laminate.

22. The method for producing a laminate according to claim 21,
wherein the UV-curable composition is applied by ink-jet printing, screen printing, spray coating, spin coating, gravure offset printing, or reverse offset printing, and the UV-curable composition is applied to part of the first adherend.
